(19) United States
(12) Patent Application Publication
(10) Pub. No.: US 2013/0082672 A1
(43) Pub. Date: Apr. 4, 2013

(54) CAPACITOR-FREE LOW DROP-OUT REGULATOR

(71) Applicants: Myeung Su KIM, Suwon (KR); Joon Hyung LIM, Gunpo (KR); Sang Hoon HWANG, Seoul (KR); Sang Hyun MIN, Yongin (KR); Han Jin CHO, Seoul (KR); Tah Joon PARK, Suwon (KR)

(72) Inventors: Myeung Su KIM, Suwon (KR); Joon Hyung LIM, Gunpo (KR); Sang Hoon HWANG, Seoul (KR); Sang Hyun MIN, Yongin (KR); Han Jin CHO, Seoul (KR); Tah Joon PARK, Suwon (KR)

(73) Assignee: SAMSUNG ELECTRO-MECHANICS CO., LTD.

(21) Appl. No.: 13/348,464

(22) Filed: Jan. 11, 2012

(30) Foreign Application Priority Data
Sep. 29, 2011 (KR) 10-2011-0098963

(51) Int. Cl. G05F 1/10

(52) U.S. Cl. 323/280

(57) ABSTRACT

There is provided a low drop-out regulator. The low drop-out regulator includes an amplifier including an odd number of operational amplifiers connected to one another in series, and an output unit including a pass transistor operated by an output from the amplifier and generating an output voltage to be applied to a load, wherein the pass transistor is an N-channel transistor, and the amplifier controls a feedback loop gain between an output terminal of one of the odd number of operational amplifiers and the output unit. The feedback loop gain may be controlled independently from the trans-conductance of the pass transistor, whereby the stable output voltage may be generated, even in the case that the load and the input voltage are changed, and the design parameter may be simplified.

### CROSS-REFERENCE TO RELATED APPLICATIONS

This application claims the priority of Korean Patent Application No. 10-2011-0098963 filed on Sep. 29, 2011, in the Korean Intellectual Property Office, the disclosure of which is incorporated herein by reference.

### BACKGROUND OF THE INVENTION

1. Field of the Invention

The present invention relates to a capacitor-free low drop-out regulator able to obtain stable output without requiring a separate external capacitor and damping factor control (DFC) and easily adjust a loop gain, a damping factor, and a pole frequency using a simple design parameter.

2. Description of the Related Art

A voltage regulator is a circuit applied to various electronic devices. For example, a direct current (DC) voltage regulator may be realized in association with a static circuit that generates a rectified output voltage from a variable input DC voltage, and an output voltage should be constantly maintained in response to changes in an input voltage and an output load current. In particular, an example of a voltage regulator widely used in industrial applications is a low drop-out regulator.

The low drop-out regulator, a main circuit of a power integrated circuit (IC), uses a pole splitting method in order to significantly reduce an external element, instead of using a main pole compensating method. That is, the low drop-out regulator divides one pole into two poles in a frequency band and transmits the two divided poles using a higher frequency band and a lower frequency band, respectively. Using such a method, the low drop-out regulator can compensate for frequency, even with a capacitor having a lower capacitance than in the main pole compensating method.

However, the pole splitting method has a defect in which, when a current does not flow in a load, the second pole is shifted to the lower frequency, and thus it is difficult to compensate for the frequency. In order to solve this defect, there is no choice but to apply damping factor control (DFC). Therefore, the use of DFC increases the complexity of the entire circuit and increases the number of design parameters affecting circuit characteristics, such as a damping factor, a pole frequency, and a loop gain, and thus it may be difficult to control design parameters so as to obtain desired characteristics, and stability may be significantly changed due to an error in the design parameters.

### SUMMARY OF THE INVENTION

An aspect of the present invention provides a low drop-out regulator that can obtain stable output without requiring DFC and can thus simplify design parameters determining circuit characteristics and easily control required circuit characteristics.

According to an aspect of the present invention, there is provided a low drop-out regulator including: an amplifier including an odd number of operational amplifiers connected to one another in series and controlling a feedback loop gain, and an output unit including a pass transistor operated by an output from the amplifier and generating an output voltage to be applied to a load, wherein the pass transistor is an N-channel transistor.

The feedback loop gain may be determined by trans-conductance and equivalent series resistance of the amplifier.

The feedback loop gain of the amplifier may have at least a first pole frequency and a second pole frequency, and the first and the second pole frequencies may be determined independently from trans-conductance of the pass transistor.

The pass transistor may configure a source follower circuit.

The load may include at least a plurality of resistances and a plurality of capacitors, and a power factor may be determined by the plurality of resistances and the plurality of capacitors included in the load.

The amplifier may include a first operational amplifier, a second operational amplifier, and a third operational amplifier connected in sequence; and an input terminal of the second operational amplifier and a source terminal of the pass transistor may include a capacitor connected therebetween, the capacitor providing a mirror effect.

An output terminal of the third operational amplifier may be connected to a gate terminal of the pass transistor.

The feedback loop gain controlled by the amplifier may be a loop gain from negative feedback.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram provided for easy understanding of a low drop-out regulator according to an embodiment of the present invention;

FIG. 2 is a circuit diagram of a low drop-out regulator according to an embodiment of the present invention;

FIG. 3 is a graph illustrating a change in a phase according to a frequency of the low drop-out regulator according to the embodiment of the present invention;

FIG. 4 is a graph illustrating a change in a loop gain according to a frequency of the low drop-out regulator according to the embodiment of the present invention;

FIG. 5 is a graph illustrating an output voltage according to a change in a load current of the low drop-out regulator according to the embodiment of the present invention; and

FIG. 6 is a graph illustrating an output voltage according to a change in an input voltage of the low drop-out regulator according to the embodiment of the present invention.

### DETAILED DESCRIPTION OF THE INVENTION

Embodiments of the present invention will be described in detail with reference to the accompanying drawings. These embodiments will be described in detail for those skilled in the art in order to practice the present invention. It should be appreciated that various embodiments of the present invention are different but do not have to be exclusive. For example, specific shapes, configurations, and characteristics described in an embodiment of the present invention may be implemented in another embodiment without departing from the spirit and the scope of the present invention. In addition, it should be understood that position and arrangement of individual components in each disclosed embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

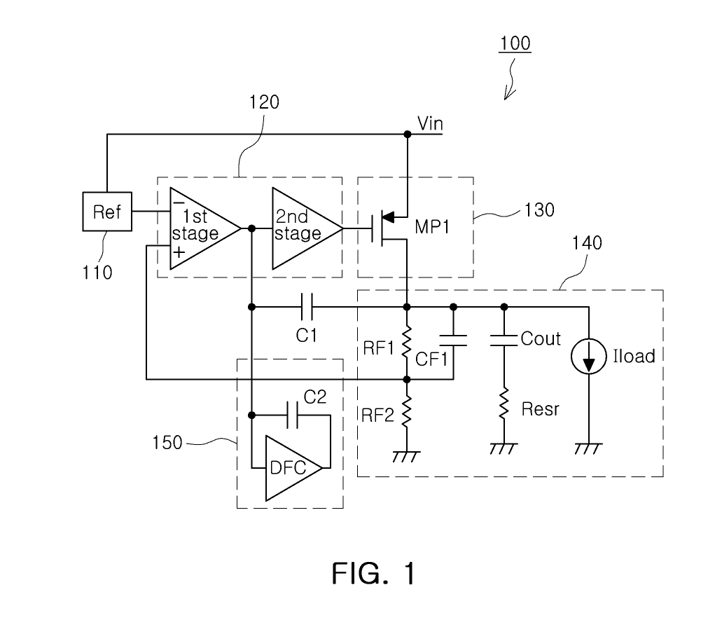

FIG. 1 is a circuit diagram provided for easy understanding of a low drop-out regulator according to an embodiment of the present invention.

A low drop-out regulator 100 shown in FIG. 1 may include a reference voltage generator 110, an amplifier 120, a transistor 130, a load 140, and a DFC circuit unit 150. The amplifier 120 may include two operational amplifiers connected in series to each other to amplify signals in two stages, and the operational amplifier of the first stage may receive an output voltage (V_{ref}) of the reference voltage generator 110 through an inverting input terminal. A non-inverting input terminal of the operational amplifier of the first stage is connected to a specific node included in the load 140 at an output terminal side so that the circuit can generally provide negative feedback.

A capacitor C1 may be connected between the operational amplifier of the first stage and the operational amplifier of the second stage, the capacitor C1 providing a mirror effect. Accordingly, even in the case that a capacitor of very low capacitance is applied as C1 in practice, relatively very high equivalent capacitance may be obtained due to a gain of the operational amplifier of the second stage. Also, the DFC circuit unit 150 may be connected between the operational amplifier of the first stage and the operational amplifier of the second stage, and may refer to a circuit that is provided to solve a defect in which it is difficult to compensate for the frequency because a pole is shifted to a low frequency band in a frequency domain, when no load is applied.

The low drop-out regulator 100 of FIG. 1 has two poles. In particular, a non-dominant pole may be determined by trans-conductance of the transistor 130 and a capacitor Cₒᵤₜ included in the load 140 at the output terminal thereof. When there is no load current (Iload=0), the trans-conductance of the transistor 130 may be relatively minimized and thus it may be difficult to compensate for the frequency. In order to solve this defect, the low drop-out regulator 100 of FIG. 1 uses both the DFC circuit unit 150 and a pole splitting method. A loop gain of the low drop-out regulator 100 of FIG. 1 is expressed by following Equation 1:

$$[ Equation 1 ]$$

$$Loop Gain = \frac{{L}_{o} ( 1 + \frac{s}{{z}_{e}} ) ( 1 + \frac{s}{{z}_{f}} )}{( 1 + \frac{s}{p 1} ) ( 1 + s ( {C}_{out} {R}_{e} + \frac{{C}_{g} {C}_{out} {g}_{m 4}}{{C}_{m 1} {g}_{m 2} {g}_{mp}} + {s}^{2} \frac{{C}_{g} {C}_{out}}{{g}_{m 2} {g}_{mp}} ) ( 1 + \frac{s}{pf} )}$$

Equation 1 may be replaced with following Equation 2:

$$[ Equation 2 ]$$

$$Loop Gain = \frac{{L}_{o} ( 1 + \frac{s}{{z}_{e}} ) ( 1 + \frac{s}{{z}_{f}} )}{( 1 + \frac{s}{p 1} ) ( 1 + s \frac{{C}_{g} {C}_{out} {g}_{m 4}}{{C}_{m 1} {g}_{m 2} {g}_{mp}} + {s}^{2} \frac{{C}_{g} {C}_{out}}{{g}_{m 2} {g}_{mp}} ) ( 1 + \frac{s}{pf} )}$$

$$Lo = \frac{RF 2}{RF 1 + RF 2} ( {g}_{m 1} {R}_{o 1} {g}_{m 2} {R}_{o 2} {g}_{mp} {r}_{op} )$$

$$p 1 = \frac{1}{{C}_{1} {R}_{o 1} {g}_{m 2} {R}_{o 2} {g}_{mp} {r}_{op}}$$

$${z}_{e} = \frac{1}{{C}_{out} {R}_{e}}$$

wherein C_{g} is gate capacitance of the transistor 130, gₘ₄ is trans-conductance of the DFC circuit unit 150, gₘ₁ is trans-conductance of the operational amplifier of the first stage, gₘ₂ is trans-conductance of the operational amplifier of the second stage, Rₒₗ is an output resistance of the operational amplifier of the first stage, Rₒ₂ is output resistance of the operational amplifier of the second stage, and Rₑ is an equivalent series resistance. The gain obtained according to the frequency by Equations 1 and 2 maybe expressed by a graph in FIG. 7.

As shown in Equations 1 and 2, there is a quadratic equation in a denominator and thus the low drop-out regulator 100 of FIG. 1 calculates a pole frequency having an imaginary number value from the quadratic equation. Accordingly, a damping factor may be calculated as follows:

$$ζ = \frac{1}{2} \sqrt{\frac{{C}_{g} {C}_{out}}{{g}_{m 2} {g}_{mp}}} * ( \frac{{g}_{m 4}}{{C}_{m 1}} ) \qquad [ Equation 3 ]$$

In order to obtain a stable output voltage (Vout), the damping factor in Equation 3 should be about 0.707, that is, 1/√2 for critical damping. A condition to achieve this may be obtained by adjusting all parameters C_{g}, Cₒᵤₜ, gₘ₂, gₘₚ, gₘ₁, and gₘ₄. As a result, since the condition to obtain the stable output voltage requires many parameter values to be adjusted, even a small error of a design parameter significantly affects output voltage stability. In particular, when no load is applied to the DFC circuit unit 150 (Iload=0), a second pole may be shifted to a low frequency band and thus it may be difficult to compensate for the frequency. In order to solve this defect, the DFC circuit unit 150 may be essentially required, and the trans-conductance (gₘ₄) of the DFC circuit unit 150 maybe added as a parameter affecting the damping factor designing, and as a result, efficiency in designing an entire circuit may be deteriorated.

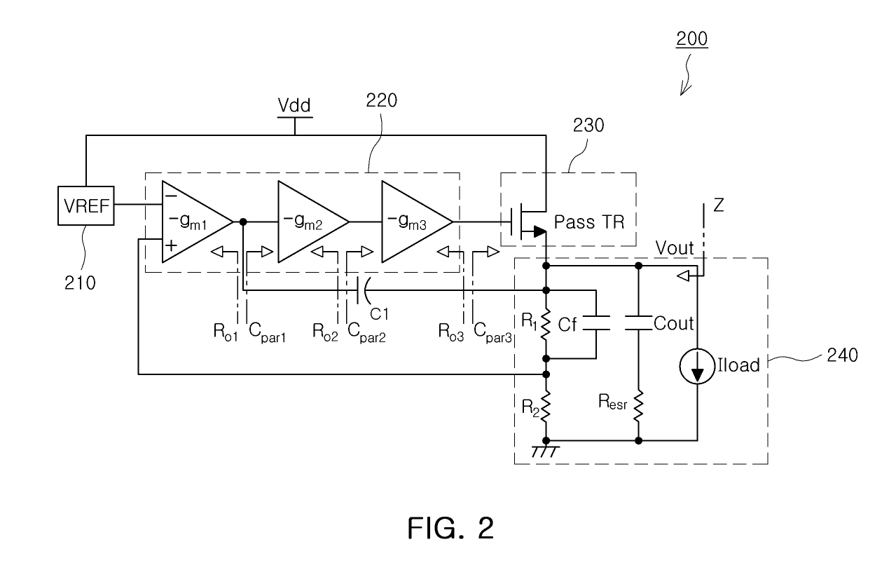

FIG. 2 is a circuit diagram illustrating a low drop-out regulator according to an embodiment of the present invention.

Referring to FIG. 2, a low drop-out regulator 200 according to an embodiment may include a reference voltage generator 210, am amplifier 220, a pass transistor 230, and a load 240. Compared with the low drop-out regulator 100 of FIG. 1, the DFC circuit unit 150 is omitted from the low drop-out regulator 200 and the low drop-out regulator 200 may include an odd number of operational amplifiers in the amplifier 220, and an N-channel transistor may be applied as the pass transistor 230.

Since the low drop-out regulator 200 of FIG. 2 does not have the DFC circuit unit 150, the number of variables included in a damping factor design parameter of an entire circuit may be reduced. Meanwhile, even in the case that there is no load current (Iload=0), the pass transistor 230 realized as the N-channel transistor may configure a source follower and does not have a gain. Therefore, a change in the trans-conductance of the pass transistor 230 may not affect an entire loop gain and thus stable output may be generated without the DFC circuit unit 150.

The loop gain of the low drop-out regulator 200 of FIG. 2 is expressed by following equation:

$$[ Equation 4 ]$$

$$Loop Gain = \frac{{g}_{m 1} {R}_{o 1} {g}_{m 2} {g}_{m 3} {R}_{o 2} {R}_{o 3} ( 1 + \frac{s}{{z}_{f}} )}{\begin{matrix}( 1 + {sR}_{o 1} {g}_{m 2} {g}_{m 3} {Z}_{real} {C}_{1} ) ( 1 + {sg}_{m 2} {g}_{m 3} ( {C}_{par 1} + {Z}_{imag} ) ) \\ ( 1 + s {R}_{o 1} {C}_{par 2} ) ( 1 + s {R}_{o 3} {C}_{par 3} ) ( 1 + \frac{s}{{p}_{f}} )\end{matrix}} * \frac{{R}_{2}}{{R}_{1} + {R}_{2}}$$

Comparing Equation 1 or 2 corresponding to the loop gain of the low drop-out regulator 100 of FIG. 1 with Equation 4, Equation 4 does not include a quadratic equation in a denominator and thus a pole having an imaginary number value is not generated. Accordingly, since the damping factor needs not be matched with a value for critical damping intentionally, the design parameter may be simplified. Thus, over-damping and under-damping needs may not be considered. A pole frequency (p_{f}) and an impedance (z_{f}) of the loop in the low drop-out regulator 200 of FIG. 2 are expressed by following equations:

$${p}_{f} = \frac{1}{{C}_{f} ( {R}_{1} \vert \vert {R}_{2} )} \\ {z}_{f} = \frac{1}{{C}_{f} {R}_{1}} \qquad [ Equation 5 ]$$

wherein the equation of the impedance (z_{f}) is an approximate expression, satisfying R₁>>R₂.

From the denominator of Equation 4, four poles in total may be obtained. Specifically, first and second poles may be obtained from first and second equations among round brackets of the denominator of Equation 4, and poles calculated by third and fourth equations thereof may correspond to poles in a high frequency domain. It can be seen from Equation 4 that both the first and the second poles calculated by the denominator of the equation of the loop gain have nothing to do with the trans-conductance of the pass transistor, and are only determined by the trans-conductance of each operational amplifier included in the amplifier 220 and the output resistance. Therefore, it may be easy to determine the design parameter to obtain a required gain.

As described above, the amplifier 220 of the low drop-out regulator 200 of FIG. 2 may include the odd number of operational amplifiers. The reason is that the pass transistor 230 configures the source follower, such that even in a case in which signals pass through the pass transistor 230, a signature thereof does not change to thereby maintain negative feedback. FIG. 2 shows a case in which three operational amplifiers are included in the amplifier 220, but the present invention is not always limited thereto.

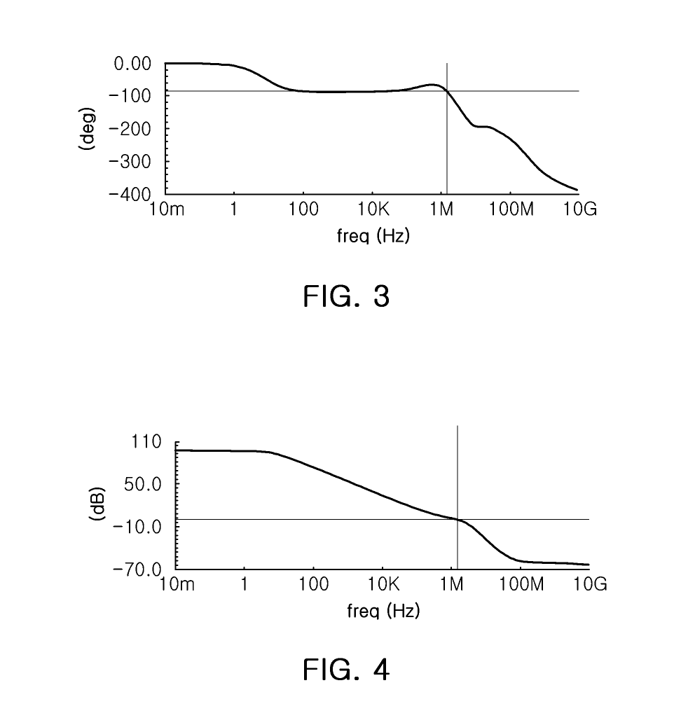

FIG. 3 is a graph illustrating a change in a phase according to a frequency of the low drop-out regulator according to the embodiment of the present invention.

Referring to FIG. 3, the low drop-out regulator 200 according to the embodiment may be operated very stably with a phase margin of about 100 degree up to the frequency of 1 MHz.

FIG. 4 is a graph illustrating a change in a loop gain according to a frequency of the low drop-out regulator according to the embodiment.

Referring to FIG. 4, the low drop-out regulator 200 according to the present embodiment shows a low pass filter pattern in which the loop gain is gradually reduced according to the frequency, and can obtain a very high responding speed since a normal operation range of the amplifier 220—a range of 0 db or higher gain—is guaranteed at a frequency of about 1 MHz. Also, referring to FIGS. 3 and 4, since the phase margin according to the frequency is maintained at about 100 degree in the normal operation range in which the loop gain of the low drop-out regulator 200 is 0 db or higher, the output voltage may be obtained stably.

As described above, comparing Equation 1 or 2 and Equation 3, the low drop-out regulator 200 of FIG. 2 does not generate a complex pole frequency unlike the low drop-out regulator 100 of FIG. 1, and a pole frequency is determined independently from the trans-conductance of the pass transistor 230. That is, the pole frequency may not be affected by the trans-conductance of the pass transistor 230. Accordingly, when a load is changed, in particular, when a load current (Iload) approaches 0, a second pole frequency is not shifted to a low frequency band in the phase-frequency graph of FIG. 3 and the gain-frequency graphs of FIG. 4, and thus, the separate DFC circuit unit 150 is not required so that the low drop-out regulator 200 may have a required gain and a required phase margin, considering only relatively few design parameters.

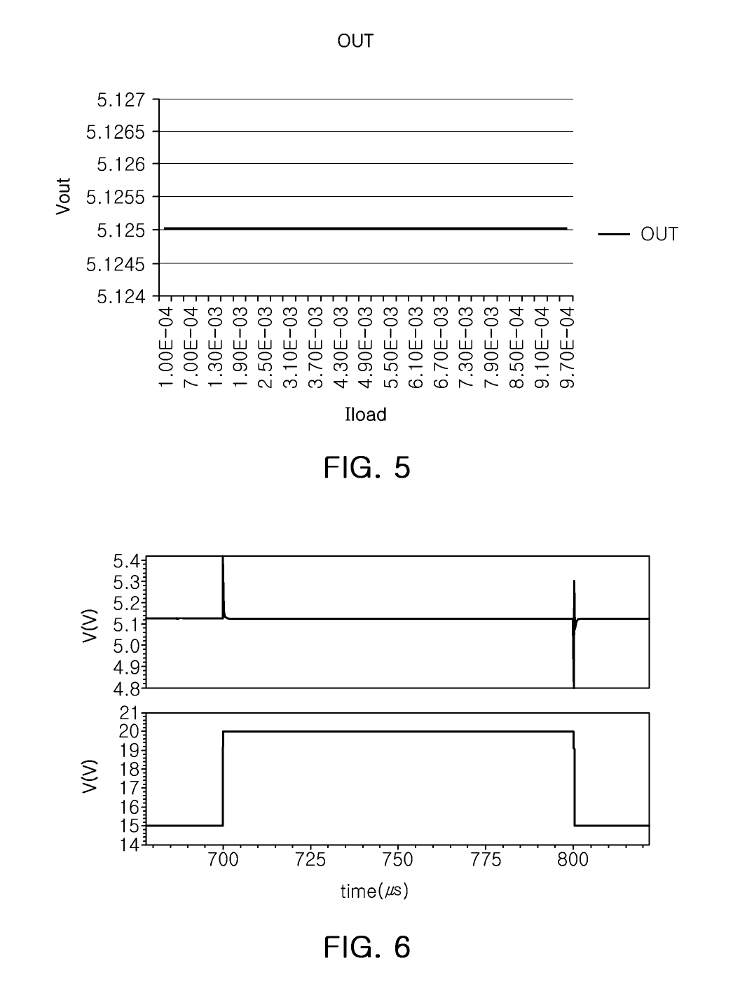

FIG. 5 is a graph illustrating an output voltage according to a change in a load current of the low drop-out regulator according to the embodiment of the present invention.

Referring to FIG. 5, a change in the output voltage (Vout) is measured while changing the load current (Iload) flowing in the load 240 from 0.1 mA to 9.7 mA on the assumption that an ideal output voltage is 5V. As described above, when the load current (Iload) has a very small value or does not exist, the second pole of the low drop-out regulator 100 shown in FIG. 1 is shifted to the low frequency band, thereby causing a defect in which it is difficult to compensate for the frequency. However, the low drop-out regulator 200 of FIG. 2 according to the embodiment of the present invention may obtain the stable output voltage without requiring the separate DFC circuit unit 150, even in the case that the load current (Iload) is relatively very low.

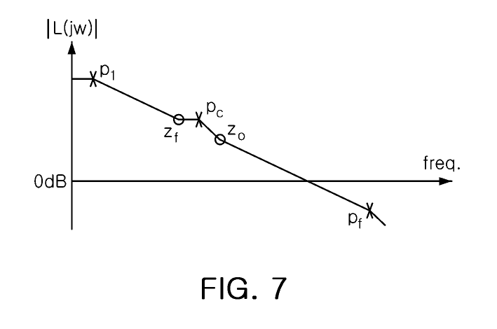

FIG. 6 is a graph illustrating an output voltage according to a change in an input voltage of the low drop-out regulator according to the embodiment of the present invention.

A graph on the upper portion of FIG. 6 indicates an output voltage (Vout) and a graph on the lower portion indicates an input voltage (Vdd). Referring to FIG. 6, at a time of 700 μs that the input voltage (Vdd) increases from 15V to 20V, the output voltage (Vout) is changed. However, the output voltage (Vout) is changed in an impulse pattern for a relatively very short time and then is immediately stabilized. Similarly, at a time of 800 μs that the input voltage (Vdd) decreases from 20V to 15V, the output voltage (Vout) is changed for a relatively very short time and then is immediately stabilized.

As described above with reference to FIGS. 3 to 6, the low drop-out regulator 200 according to the embodiment does not include the separate DFC circuit unit 150 and may obtain the stable output voltage, even in the case that the change in the load current (Iload), in particular, the Iload approaches about 0. Also, the sufficient phase margin may be guaranteed even in the wide frequency range and thus the stable operation may be guaranteed. Also, even in the case that the input voltage is significantly changed, the output voltage is changed only in an instantaneous impulse signal pattern and returns to the original output voltage within a relatively short time, so that the constant output voltage may be guaranteed regardless of the change in the input voltage.

As set forth above, according to embodiments of the present invention, the low drop-out regulator may be realized using the odd number of amplifiers and the N-channel pass transistor, so that the feedback loop gain is determined independently from the trans-conductance of the pass transistor and the complex pole is not generated in the frequency domain and thus the design parameter may be simplified. Therefore, even in the case that an error occurs in the design parameter, the stable output may be guaranteed.

While the present invention has been shown and described in connection with the embodiments, it will be apparent to those skilled in the art that modifications and variations can be made without departing from the spirit and scope of the invention as defined by the appended claims.

What is claimed is:

1. A low drop-out regulator comprising:
an amplifier including an odd number of operational amplifiers connected to one another in series; and
an output unit including a pass transistor operated by an output from the amplifier and generating an output voltage to be applied to a load,
the pass transistor being an N-channel transistor, and the amplifier controlling a feedback loop gain between an output terminal of any one of the odd number of operational amplifiers and the output unit.

2. The low drop-out regulator of claim 1, wherein the feedback loop gain is determined by trans-conductance and equivalent series resistance of the amplifier.

3. The low drop-out regulator of claim 2, wherein the feedback loop gain of the amplifier has at least a first pole frequency and a second pole frequency, and the first and the second pole frequencies are determined independently from trans-conductance of the pass transistor.

4. The low drop-out regulator of claim 3, wherein the first and the second pole frequencies are determined by trans-conductance of the operational amplifier included in the amplifier and output resistance of the operational amplifier included in the amplifier.

5. The low drop-out regulator of claim 1, wherein the pass transistor configures a source follower circuit.

6. The low drop-out regulator of claim 1, wherein the amplifier includes a first operational amplifier, a second operational amplifier, and a third operational amplifier connected in sequence; and an input terminal of the second operational amplifier and a source terminal of the pass transistor include a capacitor connected therebetween, the capacitor providing a mirror effect.

7. The low drop-out regulator of claim 6, wherein an output terminal of the third operational amplifier is connected to a gate terminal of the pass transistor.

8. The low drop-out regulator of claim 1, wherein the feedback loop gain controlled by the amplifier is a loop gain from negative feedback.

9. The low drop-out regulator of claim 1, wherein the load comprises at least one capacitor determining an impedance of the feedback loop and a pole frequency.
